(19) United States
(12) Patent Application Publication
(10) Pub. No.: US 2015/0253867 A1
(43) Pub. Date: Sep. 10, 2015

(54) KEYBOARD DEVICE WITH TOUCH CONTROL FUNCTION

(71) Applicant: Primax Electronics Ltd., Taipei (TW)

(72) Inventors: CHENG-LIN LEE, Taipei (TW); CHEN-MING CHANG, Taipei (TW); TZU-CHIANG SHIH, Taipei (TW)

(21) Appl. No.: 14/301,027

(22) Filed: Jun. 10, 2014

(30) Foreign Application Priority Data
Mar. 7, 2014 (TW) 103107995

(51) Int. Cl. G06F 3/02

(52) U.S. Cl. CPC G06F 3/021

(57) ABSTRACT

A keyboard device with a touch control function is provided. The keyboard device includes plural keys, plural first touch detectors, a second touch detector, and a controlling unit. The plural first touch detectors arranged in a row and located under a space key. The second touch detector is located under a neighboring key around the space key. If the space key and the neighboring key around the space key are sequentially touched by the user, the controlling unit sequentially receives plural first touch signal and a second touch signal. Consequently, the controlling unit issues a touch command to a computer host. Consequently, for generating the touch command, it is not necessary to change the customary gesture of the user of operating the keyboard device.

### FIELD OF THE INVENTION

The present invention relates to a keyboard device, and more particularly to a keyboard device with a touch control function.

### BACKGROUND OF THE INVENTION

Generally, the widely-used peripheral input device of a computer includes for example a mouse device, a keyboard device, a trackball device, or the like. Via the keyboard device, the user may input characters and symbols into the computer directly. As a consequence, most users and most manufacturers of the input devices pay much attention to the keyboard devices.

Hereinafter, the outer appearance of a conventional keyboard device will be illustrated with reference to FIG. 1. FIG. 1 is a schematic top view illustrating the outer appearance of a conventional keyboard device. As shown in FIG. 1, plural keys 10 are installed on a surface of the conventional keyboard device 1. These keys 10 are classified into several types, e.g. ordinary keys 101, numeric keys 102 and function keys 103. When one of these keys 10 is depressed by the user's finger, a corresponding signal is issued to the computer, and thus the computer executes a function corresponding to the depressed key. For example, when an ordinary key 101 is depressed, a corresponding English letter or symbol is inputted into the computer. When a numeric key 102 is depressed, a corresponding number is inputted into the computer. In addition, the function keys 103 (F1˜F12) can be programmed to provide various functions.

With the maturity of the computing technologies, the keyboard manufacturers make efforts in designing novel keyboard devices with special functions in order to meet diversified requirements of different users. For example, an input device for simulating a mouse device with a keyboard device is disclosed in Taiwanese Patent No. 1412957. In this patent, a judging step is performed to judge whether the depressed key is a default mouse control key. If the depressed key is not the default mouse control key, a key command corresponding to the depressed key is outputted from the input device. Whereas, if the depressed key is the default mouse control key, the input device will detect the next depressed key. Under this circumstance, the function of simulating the mouse device with the keyboard device is enabled.

After the default mouse control key is triggered and then a specified depressed key (e.g. the alphabetic key “F”) is detected, a corresponding voltage signal is outputted from the alphabetic key “F” to a keyboard controller of the input device. According to the voltage signal, the keyboard controller realizes the column-row location of the alphabetic key “F” (e.g. Column 3, Row 12). Furthermore, by the keyboard controller, the column-row location is converted into a first coordinate, e.g. (X1, Y1). After the coordinate corresponding to the alphabetic key “F” is acquired by the keyboard controller, the next depressed key is further detected by the keyboard controller. Consequently, a second coordinate corresponding to this key is acquired. For example, the second coordinate is (X2, Y2). Then, according to the first coordinate and the second coordinate, the displacement amount of the user's finger is calculated and outputted. That is, the X-axis displacement amount is equal to (X2−X1), and the Y-axis displacement amount is equal to (Y2−Y1). According to the displacement amount, the operating system in communication with the input device may control the corresponding movement of a cursor. Consequently, the purpose of utilizing the keys of the keyboards to control the movement of the cursor is achieved. After the procedure of controlling the movement of the cursor is completed, the user may depress the default mouse control key to disable the function of simulating the mouse device with the keyboard device. Consequently, the input device is returned to the general keyboard mode.

Although the input device disclosed in Taiwanese Patent No. 1412957 is capable of simulating the mouse device with the keyboard device, there are still some drawbacks. For example, the way of depressing the default mouse control key to enable or disable the function of simulating the mouse device with the keyboard device cannot satisfy the usual practice of the user.

On the other hand, as a touch sensing technology with the function of sensing gestures is gradually developed, the touch sensing technology is favored by the manufacturers of various electronic devices. Consequently, the touch sensing technology is applied to various electronic devices, including the keyboard devices. Recently, a keyboard device with a touch control function is introduced into the market. Like the input device disclosed in Taiwanese Patent No. 1412957, the touch control function of the conventional keyboard device is selectively enabled or disabled by depressing a specified function key. That is, the way of depressing the specified function key to enable or disable the touch control function still fails to satisfy the usual practice of the user.

For satisfying the usual practice of the user, there is a need of providing a keyboard device having a touch control function without switching a specified function key to enable or disable the touch control function.

### SUMMARY OF THE INVENTION

An object of the present invention provides a keyboard device with a touch control function without switching a specified function key to enable or disable the touch control function in order to satisfy the usual practice of the user.

In accordance with an aspect of the present invention, there is provided a keyboard device with a touch control function. The keyboard device is in communication with a computer host. The keyboard device includes plural keys, plural first touch detectors, a second touch detector, and a controlling unit. The plural keys are disposed on a top surface of the keyboard device. When the plural keys are depressed, plural scan codes are correspondingly generated. The plural first touch detectors are arranged in a row and located under or within a space key of the plural keys. A first touch signal is generated by the plural first touch detectors when the space key is touched, or plural first touch signals are generated by the plural first touch detectors when the space key is successively touched. The second touch detector is located under or within a neighboring key around the space key. When the neighboring key is touched, a second touch signal is generated by the second touch detector. The controlling unit is in communication with the plural keys and the compute host. If one of the scan codes is received, the controlling unit generates a corresponding key signal to the computer host. If one or more first touch signals and the second touch signal are sequentially received by the controlling unit or the second touch signal and one or more first touch signals are sequentially received by the controlling unit, the controlling unit generates a touch command to the computer host.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic top view illustrating the outer appearance of a conventional keyboard device;

FIG. 2 is a schematic exploded view illustrating a keyboard device with a touch control function according to a first embodiment of the present invention;

FIGS. 3A and 3B illustrate a flowchart of implementing a judging mechanism of the controlling unit of the keyboard device according to the first embodiment of the present invention;

FIG. 4 is a schematic exploded view illustrating a keyboard device with a touch control function according to a second embodiment of the present invention;

FIG. 5 is a schematic exploded view illustrating a keyboard device with a touch control function according to a third embodiment of the present invention;

FIG. 6 is a schematic exploded view illustrating a portion of the keyboard device according to the third embodiment of the present invention;

FIGS. 7A and 7B illustrate a flowchart of implementing a judging mechanism of the controlling unit of the keyboard device according to the third embodiment of the present invention;

FIG. 8 is a schematic exploded view illustrating a keyboard device with a touch control function according to a fourth embodiment of the present invention;

FIG. 9 is a schematic partial perspective view illustrating a keycap, a key frame and a connecting element of a key of the keyboard device according to the fourth embodiment of the present invention; and

FIG. 10 is a schematic cross-sectional and side view illustrating a portion of a keyboard device with a touch control function according to a fifth embodiment of the present invention.

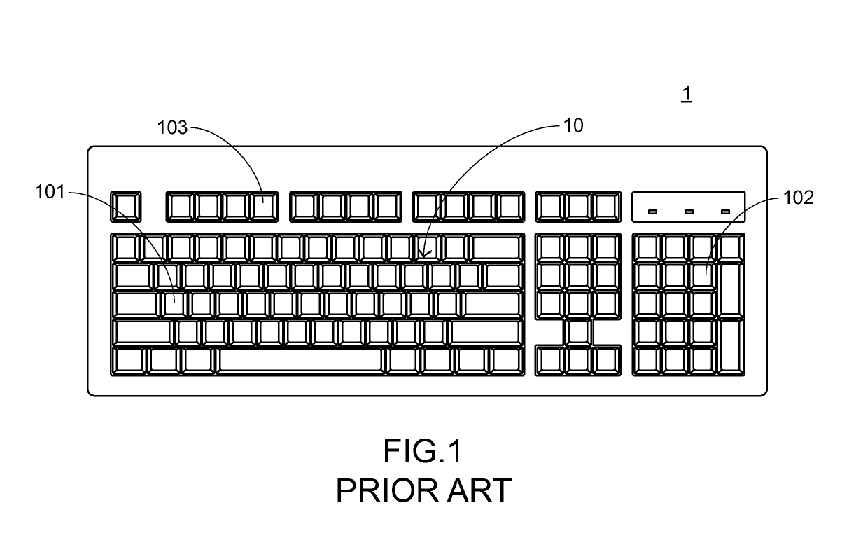

### DETAILED DESCRIPTION OF THE PREFERRED EMBODIMENT

For obviating the drawbacks of the prior art technologies, the present invention provides a keyboard device with a touch control function.

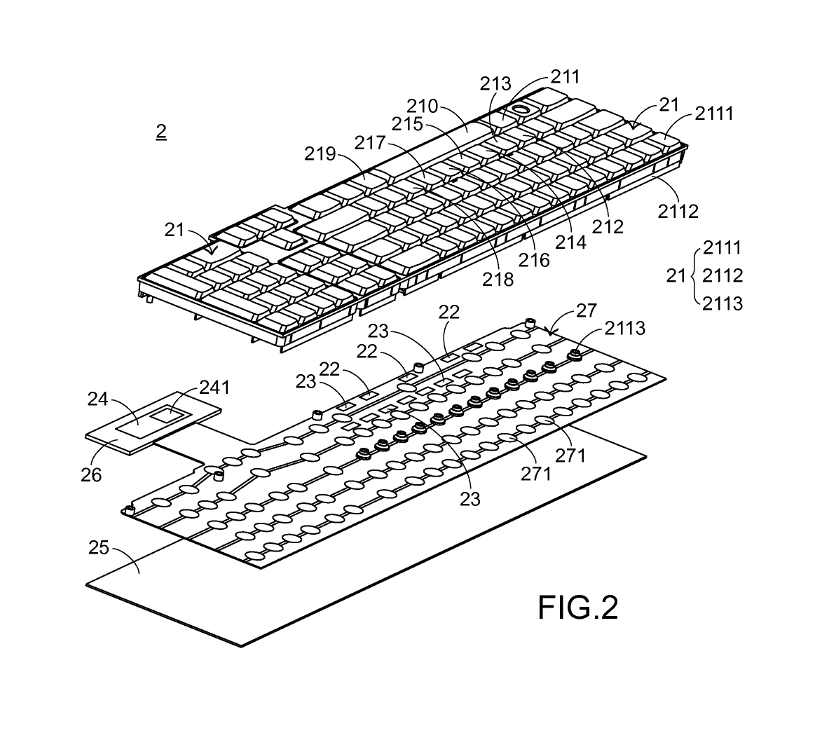

FIG. 2 is a schematic exploded view illustrating a keyboard device with a touch control function according to a first embodiment of the present invention. The keyboard device 2 is in communication with a computer host (not shown). In this embodiment, the keyboard device 2 comprises plural keys 21, plural first touch detectors 22, plural second touch sensors 23, a controlling unit 24, a supporting plate 25, a main circuit board 26, and a membrane switch circuit member 27. The plural keys 21 are disposed on a top surface of the keyboard device 2. When the plural keys 21 are depressed, corresponding scan codes (not shown) are generated. The plural first touch detectors 22 are arranged in a row and located under a space key 210 of the plural keys 21. For example, a first one of the first touch detectors 22 is located at a left side of the space key 210, a second one of the first touch detectors 22 is located at a middle region of the space key 210, and a third one of the first touch detectors 22 is located at a right side of the space key 210. When the space key 210 is touched by the user, the corresponding first touch detector 22 generates a first touch signal (not shown). The plural second touch sensors 23 are located under the keys 211˜219, which are arranged around the space key 210. When the keys 211˜219 around the space key 210 are touched by the user, the plural second touch sensors 23 generate corresponding second touch signals (not shown). In this embodiment, the keys 211-219 around the space key 210 comprise a left Alt key 211, an alphabetic key “X” 212, an alphabetic key “C” 213, an alphabetic key “V” 214, an alphabetic key “B” 215, an alphabetic key “N” 216, an alphabetic key “M” 217, a comma key “,” 218 and a right Alt key 219. In this embodiment, all of the first touch detectors 22 and the second touch sensors 23 are capacitive touch sensors, and the keyboard device 2 is a keyboard device for a desktop computer.

The supporting plate 25 is located under the plural keys 21, the main circuit board 26 and the membrane switch circuit member 27 for supporting the plural keys 21, the main circuit board 26 and the membrane switch circuit member 27. The main circuit board 26 is located at a side of the membrane switch circuit member 27, and connected with the membrane switch circuit member 27. The controlling unit 24 is disposed on the main circuit board 26. The membrane switch circuit member 27 is located under the plural keys 21, and connected with the main circuit board 26. Moreover, the membrane switch circuit member 27 comprises plural key intersections 271. When the plural key intersections 271 are triggered by the corresponding keys 21, the corresponding scan codes are generated to the controlling unit 24. In this embodiment, each of the keys 21 comprises a keycap 2111, a key frame 2112, and an elastic element 2113. The keycap 2111 is exposed outside the top surface of the keyboard device 2. When the keycap 2111 is depressed, the keycap 2111 is moved downwardly to trigger the corresponding key intersection 271. The key frame 2112 is contacted with the keycap 2111 for stopping the keycap 2111, thereby preventing detachment of the keycap 2111 from the key frame 2112. The elastic element 2113 is located under the keycap 2111 for contacting the corresponding key intersection 271 or providing an elastic force.

The operations of depressing the keys 21 will be illustrated as follows. When the keycap 2111 is depressed, the elastic element 2113 is compressed by the keycap 2111 and subjected to deformation. Consequently, the corresponding key intersection 271 is triggered to generate the corresponding scan code to the controlling unit 24. When the keycap 2111 is no longer depressed, the elastic element 2113 is restored to the original shape so as to provide an elastic force to the keycap 2111. In response to the elastic force, the keycap 2111 is moved upwardly and returned to the original position where the keycap 2111 has not been depressed. In this embodiment, the elastic element 2113 is a rubbery elastomer, but is not limited thereto. Alternatively, in some other embodiments, plural elastic elements are integrated into a rubber film (i.e. a so-called rubber sheet).

The controlling unit 24 further comprises a wireless transmission module 241. The wireless transmission module 241 contains a scan code look-up table, which is correlated with plural scan codes. The controlling unit 24 is connected with the plural keys 21 through the membrane switch circuit member 27. Moreover, the controlling unit 24 is in communication with the computer host through the wireless transmission module 241. For example, when the scan code corresponding to the alphabetic key “A” is received by the controlling unit 24, a key signal corresponding to the alphabetic key “A” is transmitted from the wireless transmission module 241 to the computer host according to the scan code look-up table. Consequently, the letter “A” is inputted into the computer host. On the other hand, when the middle region of the space key 210 is touched by the user but is not depressed, the first touch detectors 22 under the middle region of the space key 210 generates the first touch signal to the controlling unit 24. Under this circumstance, a judging mechanism associated with a touch command and a key signal is enabled by the controlling unit 24. Consequently, according to the received signal, the controlling unit 24 generates the corresponding touch command or the corresponding key signal. The judging mechanism will be illustrated later. In this embodiment, the wireless transmission module 241 may transmit the touch command or the key signal to the computer host by a Bluetooth transmission technology, and the controlling unit 24 is a microprocessor.

Please refer to FIG. 2 again. From top to bottom, the keycaps 2111, the key frames 2112, the elastic elements 2113, the plural first touch detectors 22, the plural second touch sensors 23, the membrane switch circuit member 27 and the supporting plate 25 are sequentially shown. In addition, the main circuit board 26 is located at a side of the membrane switch circuit member 27. In particular, in this embodiment, the plural first touch detectors 22 are disposed on a top surface of the membrane switch circuit member 27 and located under the keycap 2111 of the space key 210. The plural second touch sensors 23 are disposed on the top surface of the membrane switch circuit member 27, and located under the keycaps 2111 of the keys 211˜219 around the space key 210, respectively. It is noted that the positions of the plural first touch detectors 22 and the plural second touch sensors 23 are not restricted. For example, in some other embodiments, the plural first touch detectors and the plural second touch sensors are disposed on a bottom surface of the membrane switch circuit member.

In particular, the keyboard device 2 is designed in views of the customary gesture of most users while operating the keyboard device 2. In the customary gesture, two thumbs of the user are placed over the space key 201, and the remaining eight fingers are placed on other keys 21. In accordance with a feature of the present invention, the space key 201 and the keys 211˜219 around the space key 210 are utilized to generate the touch command. Consequently, it is not necessary to change the customary gesture of the user of operating the keyboard device 2. Especially, plural default touch commands corresponding to different functions are previously defined by the controlling unit 24. Moreover, these functions may be previously defined by the controlling unit 24 or defined by the user according to the preference and the usual practice.

If the first touch signal and at least one second touch signal are sequentially received or at least one second touch signal and the first touch signal are sequentially received, the corresponding touch commands are generated by the controlling unit 24. Hereinafter, some approaches of generating the plural touch commands will be illustrated. In a first approach, the space key 210 is firstly touched, and then the left Alt key 211 is touched. In a second approach, the space key 210 is firstly touched, and then the alphabetic key “X” 212 is touched. In a third approach, the space key 210 is firstly touched, and then the alphabetic key “C” 213 is touched. In a fourth approach, the space key 210 is firstly touched, and then the alphabetic key “V” 214 is touched. In a fifth approach, the space key 210 is firstly touched, and then the alphabetic key “B” 215 is touched. In a sixth approach, the space key 210 is firstly touched, and then the alphabetic key “N” 216 is touched. In a seventh approach, the space key 210 is firstly touched, and then the alphabetic key “M” 217 is touched. In an eighth approach, the space key 210 is firstly touched, and then the comma key “,” 218 is touched. In a ninth approach, the space key 210 is firstly touched, and then the right Alt key 219 is touched. In a tenth approach, the space key 210 is firstly touched, and then at least two of the keys 211˜219 are touched. In an eleventh approach, the left Alt key 211 is firstly touched, and then the space key 210 is touched. In a twelfth approach, the alphabetic key “X” 212 is firstly touched, and then the space key 210 is touched. In a thirteenth approach, the alphabetic key “C” 213 is firstly touched, and then the space key 210 is touched. In a fourteenth approach, the alphabetic key “V” 214 is firstly touched, and then the space key 210 is touched. In a fifteenth approach, the alphabetic key “B” 215 is firstly touched, and then the space key 210 is touched. In a sixteenth approach, the alphabetic key “N” 216 is firstly touched, and then the space key 210 is touched. In a seventeenth approach, the alphabetic key “M” 217 is firstly touched, and then the space key 210 is touched. In an eighteenth approach, the comma key “,” 218 is firstly touched, and then the space key 210 is touched. In a nineteenth approach, the right Alt key 219 is firstly touched, and then the space key 210 is touched. In a twentieth approach, at least two of the keys 211˜219 are firstly touched, and then the space key 210 is touched.

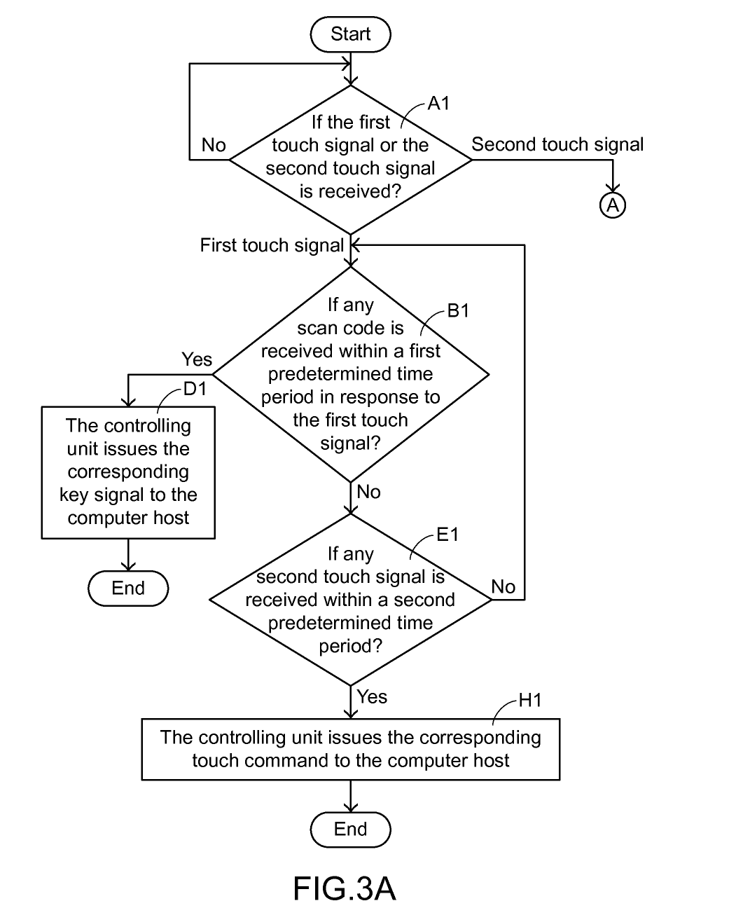

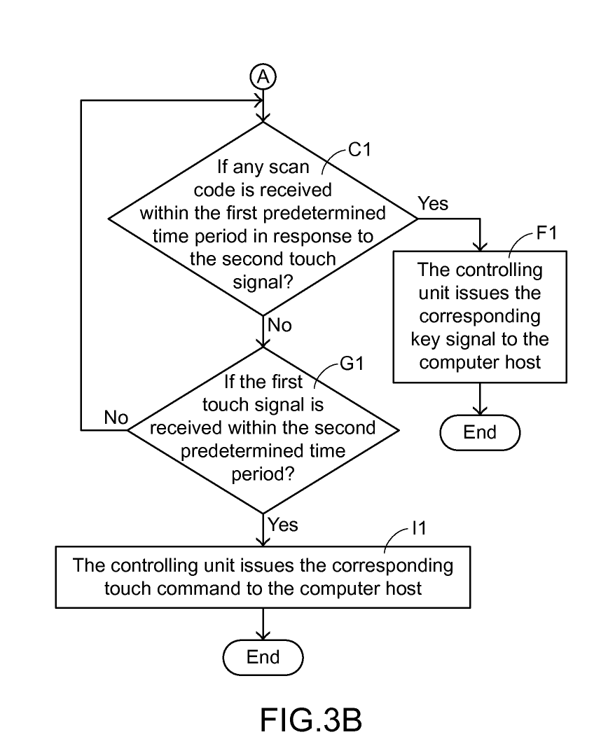

Hereinafter, the judging mechanism of performing the above triggering approaches by the controlling unit 24 will be illustrated with reference to FIGS. 2, 3A and 3B. FIGS. 3A and 3B illustrate a flowchart of implementing a judging mechanism of the controlling unit of the keyboard device according to the first embodiment of the present invention. The judging mechanism is implemented by the following steps. In a step A1, the controlling unit judges whether the first touch signal or the second touch signal is received. In a step B1, the controlling unit judges whether any scan code is received within a first predetermined time period in response to the first touch signal. In a step C1, the controlling unit judges whether any scan code is received within the first predetermined time period in response to the second touch signal. In a step D1, the controlling unit issues the corresponding key signal to the computer host. In a step E1, the controlling unit judges whether any second touch signal is received within a second predetermined time period. In a step F1, the controlling unit issues the corresponding key signal to the computer host. In a step G1, the controlling unit judges whether the first touch signal is received within the second predetermined time period. In a step H1, the controlling unit issues the corresponding touch command to the computer host. In a step I1, the controlling unit issues the corresponding touch command to the computer host.

If the controlling unit 24 receives the first touch signal in the step A1, the controlling unit 24 performs the step B1. Whereas, if the controlling unit 24 receives the second touch signal in the step A1, the controlling unit 24 performs the step C1. Whereas, if the first touch signal or the second touch signal is not received by the controlling unit 24 in the step A1, the controlling unit 24 performs the step A1 again. If the controlling unit 24 receives the scan code in the step B1, the controlling unit 24 performs the step D1. Whereas, if no scan code is received by the controlling unit 24 in the step B1, the controlling unit 24 performs the step E1. If the controlling unit 24 receives the second touch signal in the step E1, the controlling unit 24 performs the step H1. Whereas, if no second touch signal is received by the controlling unit 24 in the step E1, the controlling unit 24 performs the step B1 again. If the controlling unit 24 receives the scan code in the step C1, the controlling unit 24 performs the step F1. Whereas, if no scan code is received by the controlling unit 24 in the step C1, the controlling unit 24 performs the step G1. If the controlling unit 24 receives the first touch signal in the step G1, the controlling unit 24 performs the step I1. Whereas, if no first touch signal is received by the controlling unit 24 in the step G1, the controlling unit 24 performs the step C1 again.

Some situations of the judging mechanism will be illustrated as follows.

The judging mechanism in a first situation comprises the following steps. In the step A1, the left side of the space key 210 is touched by the user but not depressed, and thus the first touch detector 22 under the left side of the space key 210 issues a first touch signal to the controlling unit 24. Consequently, the controlling unit 24 performs the step B1. In case that the alphabetic key “C” 213 is touched by the user, the controlling unit 24 performs the step E1 and the step H1 in response to the second touch signal corresponding to the alphabetic key “C” 213. That is, in response to the first touch signal and the second touch signal corresponding to the alphabetic key “C” 213, the controlling unit 24 issues the corresponding touch command to the computer host. According to the touch command, the computer host executes the corresponding touch control function. For example, when the touch control function is executed, a web browser is activated.

The judging mechanism in a second situation comprises the following steps. In the step A1, the space key 210 is touched by the user, and thus the controlling unit 24 performs the step B1. In case that the space key 210 is depressed by the user, the controlling unit 24 performs the step D1. That is, the key signal corresponding to the space key 210 is transmitted from the controlling unit 24 to the computer host.

The judging mechanism in a third situation comprises the following steps. In the step A1, the alphabetic key “M” 217 is touched by the user but not depressed, and thus the second touch detector 23 under the alphabetic key “M” 217 issues a second touch signal to the controlling unit 24. Consequently, the controlling unit 24 performs the step C1. In case that the right side of the space key 210 is touched by the user, the first touch detector 22 under the right side of the space key 210 issues a first touch signal to the controlling unit 24. In response to the first touch signal, the controlling unit 24 performs the step G1 and the step I1. That is, in response to the second touch signal corresponding to the alphabetic key “M” 217 and the first touch signal, the controlling unit 24 issues the corresponding touch command to the computer host. According to the touch command, the computer host executes the corresponding touch control function. For example, when the touch control function is executed, a homepage of the web browser is returned.

The judging mechanism in a fourth situation comprises the following steps. In the step A1, the right Alt key 219 is touched by the user, and thus the controlling unit 24 performs the step C1. In case that the right Alt key 219 is depressed by the user, the controlling unit 24 performs the step F1. That is, the key signal corresponding to the right Alt key 219 is transmitted from the controlling unit 24 to the computer host.

In the above judging mechanism, the touch control function of the keyboard device 2 is triggered by a single finger of the user. It is noted that the touch control function of the keyboard device 2 may be triggered by plural fingers of the user while using the similar judging mechanism. In contrast, the controlling unit 24 may simultaneously receive plural first touch signals and then simultaneously receive plural second touch signals corresponding to the plural keys 211˜219. The principles of triggering the touch control function by the plural fingers are similar to the principles of triggering the touch control function by the single, and are not redundantly described herein. Moreover, the principles of generating the touch command by the controlling unit 24 according to the judging mechanism are well known to those skilled in the art, and are not redundantly described herein.

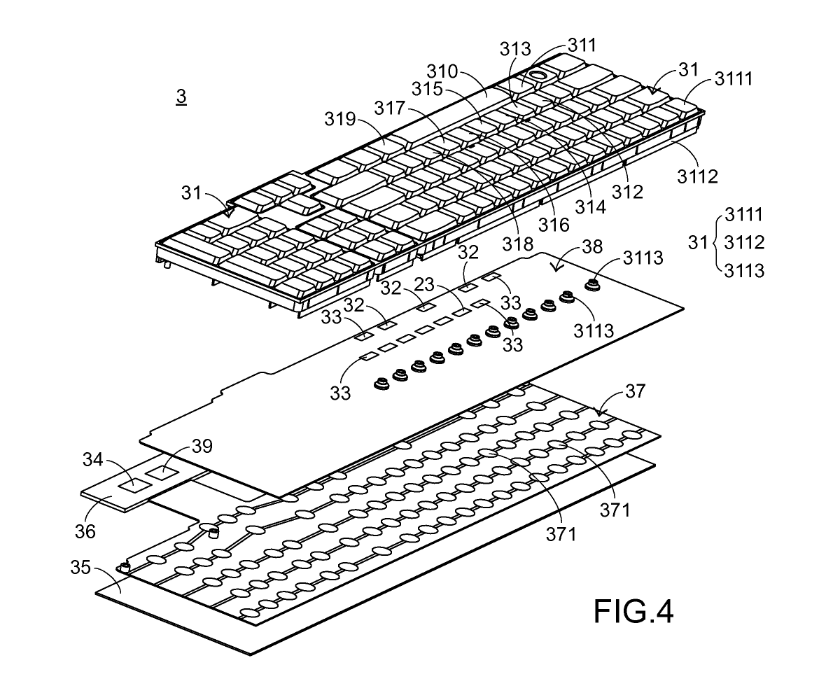

The present invention further provides a second embodiment, which is distinguished from the first embodiment. FIG. 4 is a schematic exploded view illustrating a keyboard device with a touch control function according to a second embodiment of the present invention. The keyboard device 3 comprises plural keys 31, plural first touch detectors 32, plural second touch sensors 33, a controlling unit 34, a supporting plate 35, a main circuit board 36, a membrane switch circuit member 37, a plastic film 38, and a wireless transmission module 39. In this embodiment, each of the keys 31 comprises a keycap 3111, a key frame 3112, and an elastic element 3113. For clarification and brevity, only some elastic elements 3113 are shown. In fact, each elastic element 3113 is aligned with one keycap 3111. Moreover, the membrane switch circuit member 37 comprises plural key intersections 371 corresponding to the plural keys 31, respectively.

Except for the following three items, the structures and the operations of the keyboard device 3 of this embodiment are substantially identical to those of the keyboard device 2 of the first embodiment, and are not redundantly described herein. In accordance with a first distinguished item, the wireless transmission module 39 is not included in the controlling unit 34. The wireless transmission module 39 is disposed on the main circuit board 36. The operating principles of the wireless transmission module 39 are substantially identical to those of the first embodiment, and are not redundantly described herein. Secondly, the keyboard device 3 further comprises the plastic film 38. The plastic film 38 is located over the membrane switch circuit member 37 for supporting the plural elastic elements 3113. That is, the plural elastic elements 3113 are disposed on the plastic film 38. Thirdly, the plural first touch detectors 32 are disposed on the plastic film 38 and located under the keycap 3111 of the space key 310 of the plural keys 31, and the plural second touch sensors 33 are disposed on the plastic film 38 and located under the keycaps 3111 of the keys 311˜319 around the space key 310. Consequently, from top to bottom, the keycaps 3111, the key frames 3112, the elastic elements 3113, the plural first touch detectors 32, the plural second touch sensors 33, the plastic film 38, the membrane switch circuit member 37 and the supporting plate 35 are sequentially shown. In addition, the main circuit board 36 is located at a side of the membrane switch circuit member 37.

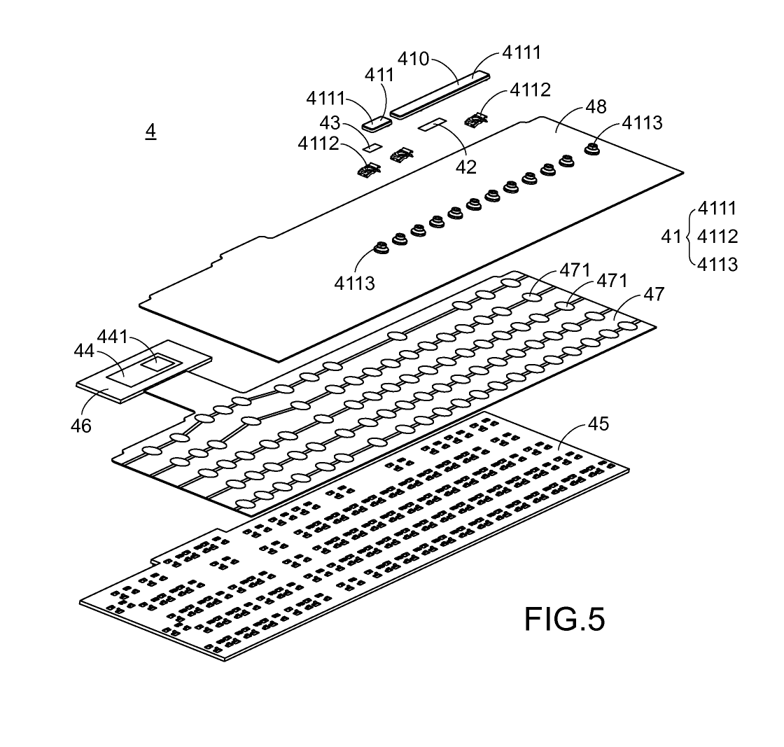

The present invention further provides a third embodiment, which is distinguished from the first embodiment. FIG. 5 is a schematic exploded view illustrating a keyboard device with a touch control function according to a third embodiment of the present invention. The keyboard device 4 is in communication with a computer host (not shown). In this embodiment, the keyboard device 4 comprises plural keys 41, plural first touch detectors 42, plural second touch sensors 43, a controlling unit 44, a supporting plate 45, a main circuit board 46, a membrane switch circuit member 47, and a plastic film 48. For brevity, only one second touch sensor 43 is shown in the drawing. The plural keys 41 are disposed on a top surface of the keyboard device 4. When the plural keys 41 are depressed, corresponding scan codes (not shown) are generated. The plural first touch detectors 42 are arranged in a row and disposed within a space key 410 of the plural keys 41. When the space key 410 is touched by the user, one of the plural first touch detectors 42 generates a first touch signal (not shown). When the space key 410 is continuously touched by the user, for example the user's finger slides from the left side of the space key 410 to the right side of the space key 410, the first touch detectors 42 generate plural first touch signals sequentially. That is, the plural first touch detectors 42 successively generate plural first touch signals.

The plural second touch sensors 43 are disposed within the neighboring keys 411 which are arranged around the space key 410. For clarification and brevity, only one of the neighboring keys 411 is shown in FIG. 5. When the neighboring keys 411 around the space key 410 are touched by the user, the plural second touch sensors 43 generates corresponding second touch signals (not shown). In this embodiment, the neighboring keys 411 around the space key 410 comprise a left Alt key, an alphabetic key “X”, an alphabetic key “C”, an alphabetic key “V”, an alphabetic key “B”, an alphabetic key “N”, an alphabetic key “M”, a comma key “,” and a right Alt key. In this embodiment, all of the first touch detectors 42 and the second touch sensors 43 are capacitive touch sensors, and the keyboard device 4 is a keyboard device for a notebook computer.

As shown in FIG. 5, the supporting plate 45 is located under the plural keys 41, the main circuit board 46 and the membrane switch circuit member 47 for supporting the plural keys 41, the main circuit board 46 and the membrane switch circuit member 47. The main circuit board 46 is located at a side of the membrane switch circuit member 47, and connected with the membrane switch circuit member 47. The controlling unit 44 is disposed on the main circuit board 46. The membrane switch circuit member 47 is located under the plural keys 41, and connected with the main circuit board 46. Moreover, the membrane switch circuit member 47 comprises plural key intersections 471. When the plural key intersections 471 are triggered by the corresponding keys 41, the corresponding scan codes are generated to the controlling unit 44. Moreover, the plastic film 48 is disposed over the membrane switch circuit member 47.

In this embodiment, each of the keys 41 comprises a keycap 4111, a connecting element 4112, and an elastic element 4113. The keycap 4111 is exposed outside the top surface of the keyboard device 4. When the keycap 4111 is depressed, the keycap 4111 is moved downwardly to trigger the corresponding key intersection 471. The connecting element 4112 is arranged between the supporting plate 45 and the keycap 4111. The connecting element 4112 is used for connecting the keycap 4111 and the supporting plate 45 and allowing the keycap 4111 to be moved upwardly or downwardly relative to the supporting plate 45. The elastic element 4113 is located under the keycap 4111 and disposed on the plastic film 48. The elastic element 4113 is used for contacting the corresponding key intersection 471 or providing an elastic force. In this embodiment, the connecting element 4112 is a scissors-type connecting element, and the elastic element 4113 is a rubbery elastomer.

The operations of depressing the keys 41 will be illustrated as follows. When the keycap 4111 is depressed and moved downwardly, the connecting element 4112 is switched from an open-scissors state to a folded state. In addition, the elastic element 4113 is compressed by the keycap 4111 and subjected to deformation. Consequently, the corresponding key intersection 471 is triggered to generate the corresponding scan code to the controlling unit 44. When the keycap 4111 is no longer depressed, the elastic element 4113 is restored to the original shape so as to provide an elastic force to the keycap 4111. In response to the elastic force, the keycap 4111 is moved upwardly and returned to the original position where the keycap 4111 has not been depressed. As the keycap 4111 is returned to the original position, the connecting element 4112 is restored to its original shape.

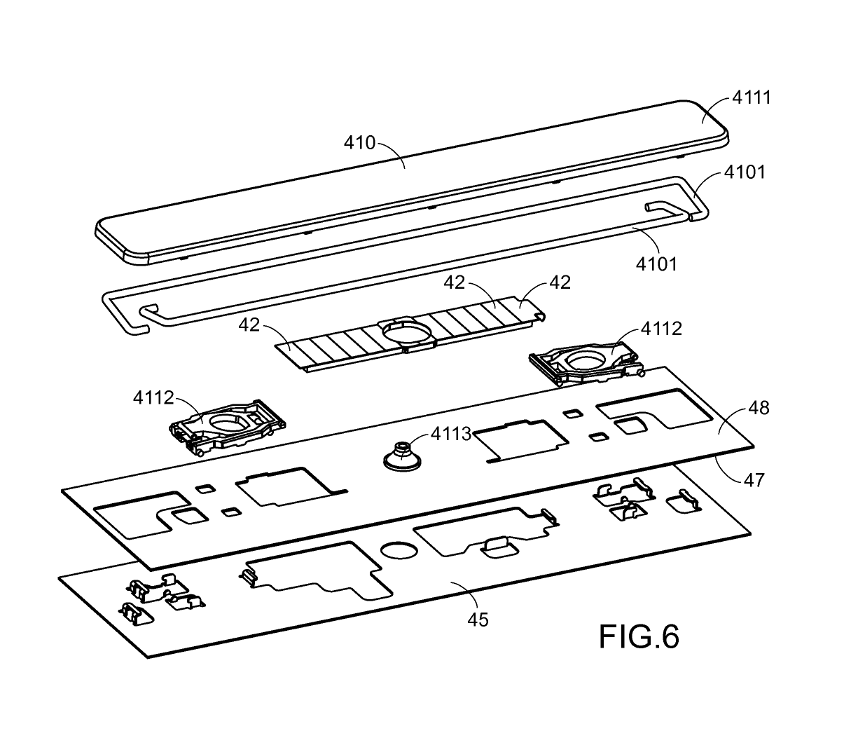

Hereinafter, the relative locations between the plural first touch detectors 42 and the space key 410 will be illustrated with reference to FIGS. 5 and 6. FIG. 6 is a schematic exploded view illustrating a portion of the keyboard device according to the third embodiment of the present invention. In FIG. 6, the arrangements of the plastic film 48 and the membrane switch circuit member 47 are shown. Moreover, the space key 410 further comprises plural reinforcement rings 4101. The plural reinforcement rings 4101 are located under the keycap 4111 of the space key 410. Since the space key 410 has an elongated shaped, the structural strength of the space key 410 is weak. The arrangement of the plural reinforcement rings 4101 within the space key 410 can enhance the structural strength of the keycap 4111 of the space key 410. The plural first touch detectors 42 are integrally formed with each other. Moreover, the plural first touch detectors 42 are disposed on a bottom surface of the keycap 4111 of the space key 410. When the space key 410 is touched by the user, the corresponding first touch signals will be generated by the corresponding first touch detectors 42. Although the plural first touch detectors 42 are disposed on the bottom surface of the keycap 4111 of the space key 410, the plural first touch detectors 42 are electrically connected with the membrane switch circuit member 47. That is, the first touch signals may be transmitted from the first touch detectors 42 to the controlling unit 44 through the membrane switch circuit member 47.

As shown in FIG. 5, the controlling unit 44 further comprises a wireless transmission module 441. The wireless transmission module 441 contains a scan code look-up table, which is correlated with plural scan codes. The operations of the wireless transmission module 441 are similar to those of the wireless transmission module 241 of the firs embodiment, and are not redundantly described herein. The controlling unit 44 is connected with the plural keys 41 through the membrane switch circuit member 47. Moreover, the controlling unit 44 is in communication with the computer host through the wireless transmission module 441.

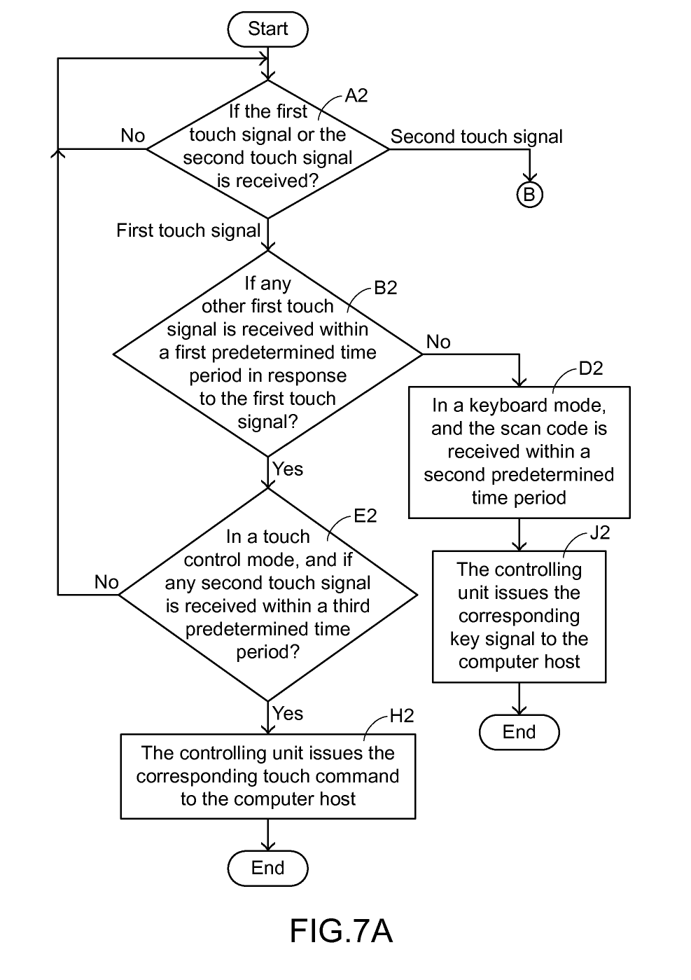

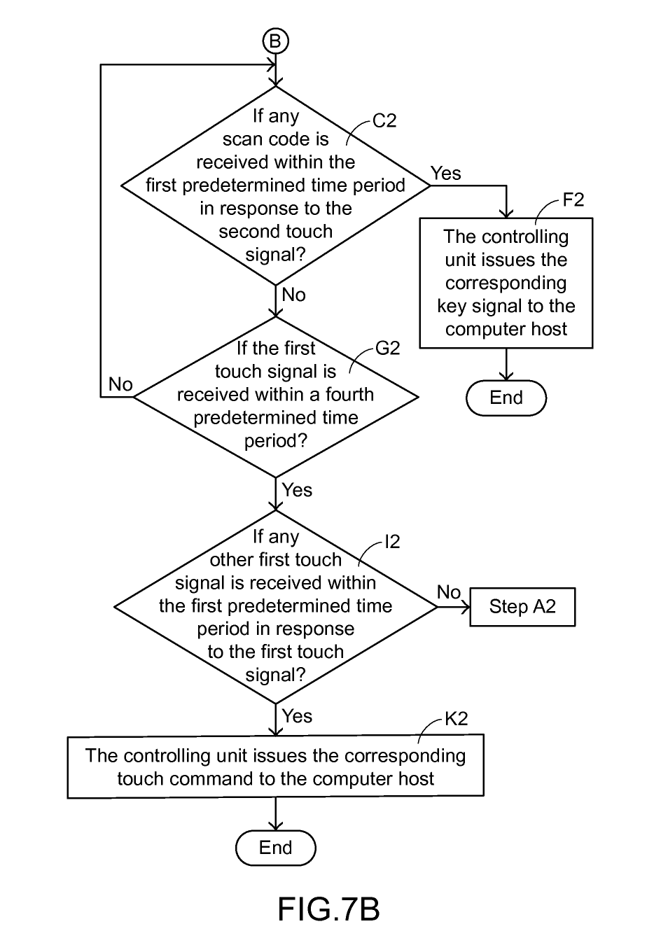

Hereinafter, the judging mechanism of the controlling unit 44 will be illustrated with reference to FIGS. 7A and 7B. FIGS. 7A and 7B illustrate a flowchart of implementing a judging mechanism of the controlling unit of the keyboard device according to the third embodiment of the present invention.

The judging mechanism of the controlling unit 44 in this embodiment is distinguished from the judging mechanism of the controlling unit 24 of the first embodiment. The judging mechanism of this embodiment is implemented by the following steps. In a step A2, the controlling unit judges whether the first touch signal or the second touch signal is received. In a step B2, the controlling unit judges whether any other first touch signal is received within a first predetermined time period in response to the first touch signal. In a step C2, the controlling unit judges whether any scan code is received within the first predetermined time period in response to the second touch signal. In a step D2, the controlling unit allows the keyboard device to be operated in a keyboard mode, and judges whether any scan code is received within a second predetermined time period. In a step E2, the controlling unit allows the keyboard device to be operated in a touch control mode, and judges whether any second touch signal is received within a third predetermined time period. In a step F2, the controlling unit issues the corresponding key signal to the computer host. In a step G2, the controlling unit judges whether the first touch signal is received within a fourth predetermined time period. In a step H2, the controlling unit issues the corresponding touch command to the computer host. In a step I2, the controlling unit judges whether any other first touch signal is received within the first predetermined time period in response to the first touch signal. In a step J2, the controlling unit issues the corresponding key signal to the computer host. In a step K2, the controlling unit issues the corresponding touch command to the computer host.

If the controlling unit 44 receives the first touch signal in the step A2, the controlling unit 44 performs the step B2. Whereas, if the controlling unit 44 receives the second touch signal in the step A2, the controlling unit 44 performs the step C2. Whereas, if the first touch signal or the second touch signal is not received by the controlling unit 44 in the step A2, the controlling unit 44 performs the step A2 again. If the controlling unit 44 receives any other first touch signal in the step B2, the controlling unit 44 performs the step E2. Whereas, if no additional first touch signal is received by the controlling unit 44 in the step B2, the controlling unit 44 performs the step D2. If the controlling unit 44 receives the second touch signal in the step E2, the controlling unit 44 performs the step H2. Whereas, if no second touch signal is received by the controlling unit 44 in the step E2, the controlling unit 44 performs the step A2 again. If the controlling unit 44 receives the scan code in the step C2, the controlling unit 44 performs the step F2. Whereas, if no scan code is received by the controlling unit 44 in the step C2, the controlling unit 44 performs the step G2. If the controlling unit 44 receives the first touch signal in the step G2, the controlling unit 44 performs the step I2. Whereas, if no first touch signal is received by the controlling unit 44 in the step G2, the controlling unit 44 performs the step C2 again. If the controlling unit 44 receives any other first touch signal in the step I2, the controlling unit 44 performs the step K2. Whereas, if no additional first touch signal is received by the controlling unit 44 in the step I2, the controlling unit 44 performs the step A2 again. The step B2 and the step 12 are used to prevent from erroneous judgment that is caused by erroneously touching the space key 410. That is, the conditions of the step B2 and the step I2 are satisfied when the space key 410 is successively touched. Under this circumstance, the touch control function can be enabled. On the other hand, if the conditions of the step B2 and the step I2 are not satisfied, the keyboard device 4 is continuously in the keyboard mode.

Some situations of the judging mechanism will be illustrated as follows.

The judging mechanism in a first situation comprises the following steps. In the step A2, the left side of the space key 410 is touched by the user but not depressed, and thus the first touch detector 42 under the left side of the space key 410 issues a first touch signal to the controlling unit 44. Consequently, the controlling unit 44 performs the step B2. In case that the user's finger is slid from the left side of the space key 410 to the middle region of the space key 410, the controlling unit 44 performs the step E2 in response to the successively-received first touch signal. Then, in case that the user's finger is moved from the middle region of the space key 410 to the alphabetic key “B” so as to touch the alphabetic key “B”, the controlling unit 44 performs the step H2 in response to the second touch signal corresponding to the alphabetic key “B”. That is, in response to the successive first touch signals and the second touch signal corresponding to the alphabetic key “B”, the controlling unit 44 issues the corresponding touch command to the computer host. According to the touch command, the computer host executes the corresponding touch control function. For example, when the touch control function is executed, a music player is activated.

The judging mechanism in a second situation comprises the following steps. The step A2 and the step B2 as described in the first situation are sequentially performed. In case that the space key 410 is directly depressed by the user in the step B2, the controlling unit 44 performs the step D2 and the step J2. That is, the key signal corresponding to the space key 410 is transmitted from the controlling unit 44 to the computer host.

The judging mechanism in a third situation comprises the following steps. The step A2, the step B2 and the step E2 as described in the first situation are sequentially performed. In case that no second touch signal is received by the controlling unit 44 in the step E2, the controlling unit 44 performs the step A2 again. Under this circumstance, the judging mechanism is repeatedly implemented.

The judging mechanism in a fourth situation comprises the following steps. In the step A2, the alphabetic key “V” is touched by the user but not depressed, and thus the second touch detector 43 under the alphabetic key “V” issues a second touch signal to the controlling unit 44. Then, the controlling unit 44 performs the step C2. In case that the left side of the space key 410 is then touched by the user, the controlling unit 44 performs the step G2. In response to the first touch signal generated by the first touch detector 42 under the left side of the space key 410, the controlling unit 44 performs the step I2. In case that the user's finger is slid from the left side of the space key 410 to the right region of the space key 410, the controlling unit 44 performs the step K2 in response to the successively-received first touch signal. That is, in response to the second touch signal corresponding to the alphabetic key “V” and the successive first touch signals, the controlling unit 44 issues the corresponding touch command to the computer host. According to the touch command, the computer host executes the corresponding touch control function. For example, when the touch control function is executed, the playback of the music player is paused.

The judging mechanism in a fifth situation comprises the following steps. The step A2 and the step C2 as described in the fourth situation are sequentially performed. In case that the alphabetic key “V” is directly depressed by the user in the step C2, the controlling unit 44 performs the step F2. That is, That is, the key signal corresponding to the alphabetic key “V” is transmitted from the controlling unit 44 to the computer host.

The judging mechanism in a sixth situation comprises the following steps. The step A2, the step C2 and the step G2 as described in the fourth situation are sequentially performed. In case that no first touch signal is received by the controlling unit 44 in the step G2, the controlling unit 44 performs the step C2 again in order to judge whether any key 41 is depressed.

The judging mechanism in a seventh situation comprises the following steps. The step A2, the step C2, the step G2 and the step I2 as described in the fourth situation are sequentially performed. In case that no first touch signal is received by the controlling unit 44 in the step I2, the controlling unit 44 performs the step A2 again. Under this circumstance, the judging mechanism is repeatedly implemented.

In the above judging mechanism, the touch control function of the keyboard device 4 is triggered by a single finger of the user. It is noted that the touch control function of the keyboard device 4 may be triggered by plural fingers of the user while using the similar judging mechanism. In contrast, the controlling unit 44 may simultaneously receive plural first touch signals and then simultaneously receive plural second touch signals. On the other hand, the principles of receiving plural second touch signals and then receiving the plural successive first touch signals by the controlling unit 44 are similar to the above situation, and are not redundantly described herein.

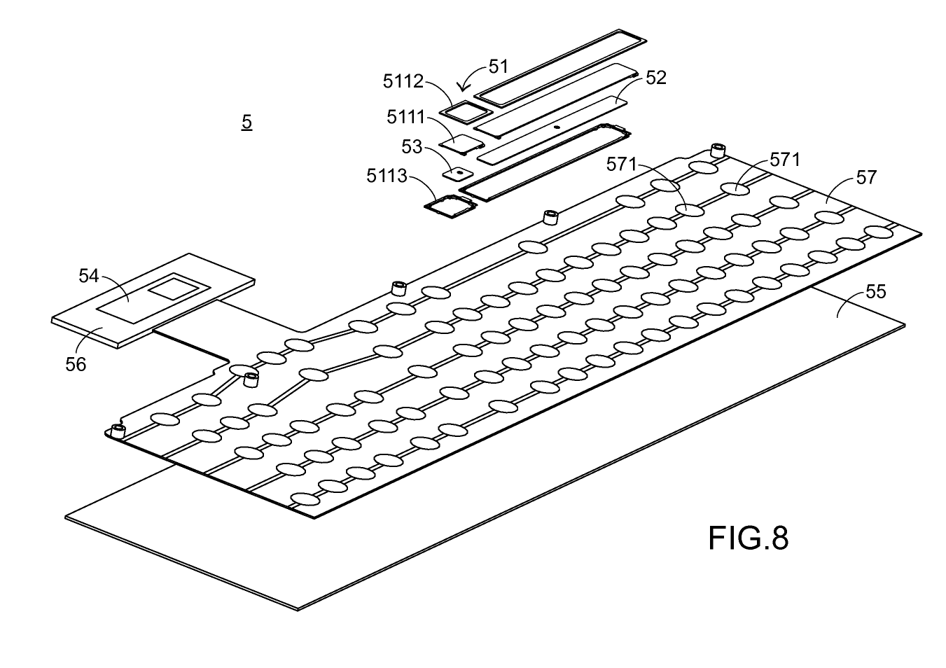

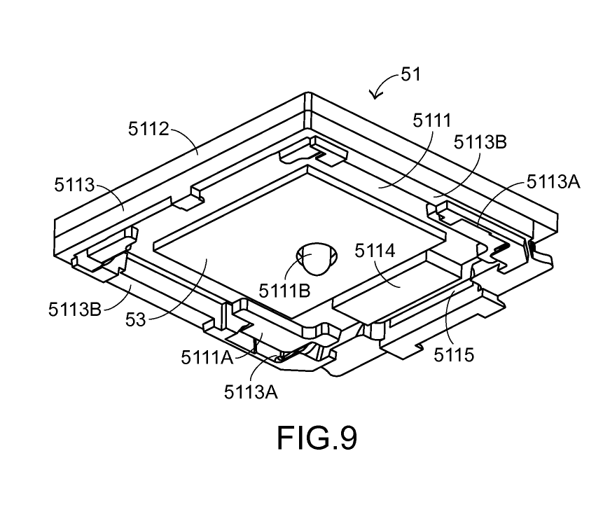

The present invention further provides a fourth embodiment, which is distinguished from the first embodiment. FIG. 8 is a schematic exploded view illustrating a keyboard device with a touch control function according to a fourth embodiment of the present invention. FIG. 9 is a schematic partial perspective view illustrating a keycap, a key frame and a connecting element of a key of the keyboard device according to the fourth embodiment of the present invention. As shown in FIGS. 8 and 9, the keyboard device 5 comprises plural keys 51, plural first touch detectors 52, plural second touch sensors 53, a controlling unit 54, a supporting plate 55, a main circuit board 56, and a membrane switch circuit member 57. In this embodiment, each of the keys 51 comprises a keycap 5111, a key frame 5112, an elastic element 5113, a first magnetic element 5114, and a second magnetic element 5115. Moreover, the membrane switch circuit member 57 comprises plural key intersections 571 corresponding to the plural keys 51. The key 51 as shown in FIG. 9 is the right Alt key. Except for the following two items, the structures and the operations of the keyboard device 5 of this embodiment are substantially identical to those of the keyboard device 2 of the first embodiment, and are not redundantly described herein. Firstly, the structure of the key 51 is distinguished. Secondly, the locations of the plural first touch detectors 52 and the plural second touch sensors 53 are distinguished.

The structure of the key 51 will be illustrated as follows. The keycap 5111 is exposed outside the top surface of the keyboard device 5. When the keycap 5111 is depressed, the keycap 5111 is moved downwardly to trigger the corresponding key intersection 571. The keycap 5111 further comprises plural bulges 5111A and a triggering part 5111B. The plural bulges 5111A are located at a second side of the keycap 5111. The triggering part 5111B is disposed on a bottom surface of the keycap 5111. The key frame 5112 is contacted with the keycap 5111 for stopping the keycap 5111, thereby preventing detachment of the keycap 5111 from the key frame 5112. Due to the key frame 5112, the keycap 5111 is permitted to be moved within a range between the key frame 5112 and the elastic element 5113 without being escaped from the key frame 5112. The connecting element 5113 is disposed under the key frame 5112 and contacted with the keycap 5111 for allowing the keycap 5111 to be moved upwardly or downwardly relative to the key frame 5112. The connecting element 5113 further comprises plural inclined guiding recesses 5113A. The plural inclined guiding recesses 5113A are formed in second sidewalls 5113B of the connecting element 5113, and aligned with the plural bulges 5111A, respectively. The first magnetic element 5114 is disposed on the keycap 5111. The second magnetic element 5115 is disposed on the connecting element 5113. The first magnetic element 5114 and the second magnetic element 5115 are magnetically attracted by each other so as to generate a magnetic force. In response to the magnetic force, the keycap 5111 is returned to its original position.

The operations of depressing the keycap 5111 will be illustrated as follows. In case that the keycap 5111 is not depressed by the user, the first magnetic element 5114 on the keycap 5111 is magnetically attracted by the second magnetic element 5115 on the connecting element 5113. When the keycap 5111 is depressed by the user and the depressing force on the keycap 5111 is larger than the magnetic force generated by the first magnetic element 5114 and the second magnetic element 5115, the plural bulges 5111A of the keycap 5111 are moved from first end (i.e. the upper end as shown in FIG. 9) of the corresponding inclined guiding recesses 5113A to second ends (i.e. the lower ends as shown in FIG. 9) of the corresponding inclined guiding recesses 5113A. That is, the keycap 5111 is moved downwardly relative to the frame body 5112. At the same time, the triggering part 5111B on the keycap 5111 is contacted with the switch circuit member 57 under the connecting element 5113 to trigger the corresponding key intersection 571 in order to generate the key signal. When the keycap 5111 is no longer depressed by the user, the magnetic force generated by the first magnetic element 5114 and the second magnetic element 5115 is no longer influenced by the depressing force. Under this circumstance, the first magnetic element 5114 is magnetically attracted by the second magnetic element 5115, and thus the first magnetic element 5114 is moved upwardly. Consequently, the plural bulges 5111A of the keycap 5111 are moved from the second ends of the corresponding inclined guiding recesses 5113A to the first ends of the corresponding inclined guiding recesses 5113A, and the keycap 5111 is returned to its original position where the keycap 5111 has not been depressed.

As shown in FIG. 9, the corresponding second touch sensor 53 is disposed on the bottom surface of the keycap 5111, and located beside the triggering part 5111B. The keycap 5111 is the keycap of the right Alt key. Similarly, in this embodiment, the plural first touch detectors 52 are disposed on a bottom surface of the keycap 5111 of the space key 510.

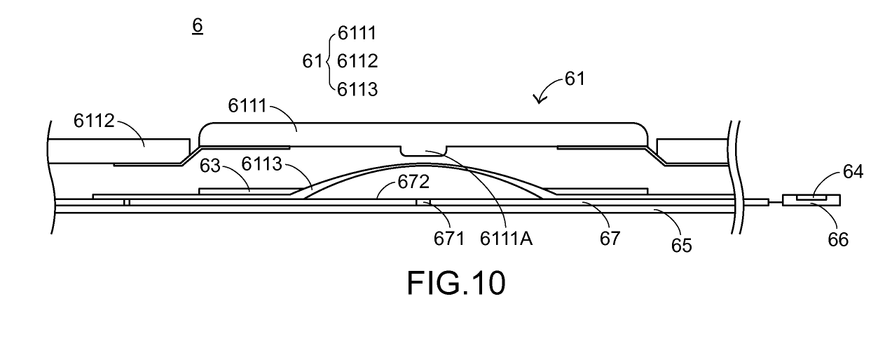

The present invention further provides a fifth embodiment, which is distinguished from the first embodiment. FIG. 10 is a schematic cross-sectional and side view illustrating a portion of a keyboard device with a touch control function according to a fifth embodiment of the present invention. As shown in FIG. 10, the keyboard device 6 comprises plural keys 61, plural first touch detectors (not shown), plural second touch sensors 63, a controlling unit 64, a supporting plate 65, a main circuit board 66, and a membrane switch circuit member 67. For clarification and brevity, only one key 61 and one second touch sensor 63 are shown in the drawing.

In this embodiment, each of the keys 61 comprises a keycap 6111, a key frame 6112, and an elastic element 6113. Moreover, the membrane switch circuit member 67 comprises plural key intersections 671 corresponding to the plural keys 61. Except for the following two items, the structures and the operations of the keyboard device 6 of this embodiment are substantially identical to those of the keyboard device 3 of the second embodiment, and are not redundantly described herein. Firstly, the locations of the plural first touch detectors and the plural second touch sensors 63 are distinguished. Secondly, the structure of the key 61 is distinguished.

In accordance with the first distinguished item, the plural first touch detectors and the plural second touch sensors 63 are disposed on a top surface 672 of the membrane switch circuit member 67 and located at a side of the elastic element 6113. It is noted that the location of the plural first touch detectors and the plural second touch sensors are not restricted. For example, in some other embodiments, the plural first touch detectors and the plural second touch sensors are disposed on a bottom surface of the membrane switch circuit member 67 or a bottom surface of the keycap 6111.

In accordance with the second distinguished item, the keycap 6111 is exposed outside the top surface of the keyboard device 6. When the keycap 6111 is depressed, the keycap 6111 is moved downwardly to trigger the corresponding key intersection 671. The keycap 6111 further comprises a triggering part 6111A. The triggering part 6111A is disposed on a bottom surface of the keycap 6111. The key frame 6112 is contacted with the keycap 6111 for stopping the keycap 6111, thereby preventing detachment of the keycap 6111 from the key frame 6112. The elastic element 6113 is disposed under the keycap 6111 and contacted with the keycap 6111. Due to the elastic element 6113, the keycap 6111 is not contacted with the underlying key intersection 671. When the keycap 6111 is depressed, the elastic element 6113 is subjected to deformation and thus contacted with the corresponding key intersection 671. Consequently, the corresponding key signal is generated. When the keycap 6111 is no longer depressed, the elastic element 6113 is restored to the original shape so as to provide an elastic force to the keycap 6111. In response to the elastic force, the keycap 6111 is returned to the original position. In this embodiment, the elastic element 6113 is made of a metallic material.

In the above embodiments, the locations of the plural first touch detectors and the plural second touch sensors of various types of keys may be varied according to the structures of the keyboard devices. For example, the plural first touch detectors and the plural second touch sensors of the first embodiment may be disposed within the corresponding keys, i.e. on the bottom surfaces of the keycaps. Moreover, the plural first touch detectors and the plural second touch sensors of the third embodiment may be disposed on the plastic film. Moreover, the plural first touch detectors and the plural second touch sensors of the fourth embodiment may be disposed on the bottom surface or the top surface of the membrane switch circuit member.

From the above descriptions, the present invention provides a keyboard device with a touch control function. The keyboard device comprises plural first touch detectors, plural second touch detectors and a judging mechanism of a controlling device. The plural first touch detectors are located within or under the space key. Moreover, the plural second touch detectors are located within or under some keys around the space key. In particular, the keyboard device of the present invention may generate the touch command by sequentially touching the space key and the neighboring key around the space key or sequentially touching the neighboring key around the space key and the space key. That is, the keyboard device of the present invention may generate the touch command without the need of depressing the switch key of switching the operating mode between the keyboard mode and the touch control mode or depressing the hot key of switching the operating mode between the keyboard mode and the touch control mode. Moreover, the keyboard device of the present invention is designed in views of the customary gesture of most users while operating the keyboard device. Consequently, it is not necessary to change the customary gesture of the user of operating the keyboard device in the keyboard mode or the touch control mode. In other words, the keyboard device of the present invention can satisfy the usual practice of the user. In comparison with the conventional keyboard device, the keyboard device of the present invention can satisfy the usual practice of the user without need of interrupting the customary gesture of operating the keyboard device. Moreover, since the keyboard device of the present invention can be intuitively operated, the keyboard device of the present invention is more user-friendly.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A keyboard device with a touch control function, the keyboard device being in communication with a computer host, the keyboard device comprising:
plural keys disposed on a top surface of the keyboard device, wherein when the plural keys are depressed, plural scan codes are correspondingly generated;
plural first touch detectors arranged in a row and located under or within a space key of the plural keys, wherein a first touch signal is generated by the plural first touch detectors when the space key is touched, or plural first touch signals are generated by the plural first touch detectors when the space key is successively touched;
a second touch detector located under or within a neighboring key around the space key, wherein when the neighboring key is touched, a second touch signal is generated by the second touch detector; and
a controlling unit in communication with the plural keys and the compute host, wherein if one of the scan codes is received, the controlling unit generates a corresponding key signal to the computer host, wherein if one or more first touch signals and the second touch signal are sequentially received by the controlling unit or the second touch signal and one or more first touch signals are sequentially received by the controlling unit, the controlling unit generates a touch command to the computer host.

2. The keyboard device according to claim 1, wherein if the first touch signal is received by the controlling unit, the controlling unit judges whether any scan code of the plural scan codes is received within a first predetermined time period, wherein if the scan code is received by the controlling unit within the first predetermined time period, the controlling unit issues the corresponding key signal to the computer host, wherein if the scan code is not received by the controlling unit within the first predetermined time period, the controlling unit judges whether the second touch signal is received within a second predetermined time period, wherein if the second touch signal is received by the controlling unit within the second predetermined time period, the controlling unit issues the touch command to the computer host, wherein if the second touch signal is not received by the controlling unit within the second predetermined time period, the controlling unit judges again whether the scan code is received within the first predetermined time period.

3. The keyboard device according to claim 1, wherein if the first touch signal is received by the controlling unit, the controlling unit judges whether any other first touch signal is received within a first predetermined time period, wherein if no additional first touch signal is received by the controlling unit within the first predetermined time period, the controlling unit allows the keyboard device to be operated in a keyboard mode and judges whether any scan code of the plural scan codes is received within a second predetermined time period, wherein if an additional first touch signal is received by the controlling unit within the first predetermined time period, the controlling unit allows the keyboard device to be operated in a touch control mode and judges whether the second touch signal is received within a third predetermined time period, wherein if the second touch signal is received by the controlling unit within the third predetermined time period, the controlling unit issues the touch command to the computer host, wherein if the second touch signal is not received by the controlling unit within the third predetermined time period, the controlling unit allows the keyboard device to be operated in the keyboard mode and judges again whether the scan code is received within the second predetermined time period.

4. The keyboard device according to claim 1, wherein if the second touch signal is received by the controlling unit, the controlling unit judges whether any scan code of the plural scan codes is received within a first predetermined time period, wherein if the scan code is received by the controlling unit within the first predetermined time period, the controlling unit issues the corresponding key signal to the computer host, wherein if the scan code is not received by the controlling unit within the first predetermined time period, the controlling unit judges whether the first touch signal is received within a second predetermined time period, wherein if the first touch signal is received by the controlling unit within the second predetermined time period, the controlling unit issues the touch command to the computer host, wherein if the first touch signal is not received by the controlling unit within the second predetermined time period, the controlling unit judges again whether the scan code is received within the first predetermined time period.

5. The keyboard device according to claim 1, wherein if the second touch signal is received by the controlling unit, the controlling unit judges whether any scan code of the plural scan codes is received within a first predetermined time period, wherein if the scan code is received by the controlling unit within the first predetermined time period, the controlling unit issues the corresponding key signal to the computer host, wherein if the scan code is not received by the controlling unit within the first predetermined time period, the controlling unit judges whether the first touch signal is received within a second predetermined time period, wherein if the first touch signal is received by the controlling unit within the second predetermined time period, the controlling unit judges whether any other first touch signal is received within a third predetermined time period, wherein if no additional first touch signal is received by the controlling unit within the third predetermined time period, the controlling unit allows the keyboard device to be operated in a keyboard mode and judges again whether the scan code is received within a first predetermined time period, wherein if an additional first touch signal is received by the controlling unit within the third predetermined time period, the controlling unit allows the keyboard device to be operated in a touch control mode and issues the touch command to the computer host.

6. The keyboard device according to claim 1, further comprising:
a supporting plate, wherein the plural keys are supported by the supporting plate;
a main circuit board, wherein the controlling unit is disposed on the main circuit board; and
a membrane switch circuit member located under the plural keys and connected with the main circuit board, and comprising plural key intersections, wherein when one of the key intersections is triggered, the corresponding scan code is generated, wherein each of the plural keys comprises:
a keycap exposed outside the top surface of the keyboard device;
a connecting element arranged between the supporting plate and the keycap, wherein the supporting plate and the keycap are connected with each other, and the keycap is movable upwardly or downwardly relative to the supporting plate through the connecting element; and
an elastic element located under the keycap, wherein the elastic element triggers the corresponding key intersection when the keycap is depressed, or the elastic element provides an elastic force to the keycap so as to return the keycap to an original position.

7. The keyboard device according to claim 6, wherein the plural first touch detectors are disposed on the membrane switch circuit member and located under the keycap of the space key, and the second touch sensor is disposed on the membrane switch circuit member and located under the keycap of the neighboring key around the space key, or wherein the plural first touch detectors are disposed on a bottom surface of the keycap of the space key, and the second touch sensor is disposed on a bottom surface of the keycap of the neighboring key around the space key.

8. The keyboard device according to claim 6, further comprising a plastic film, wherein the plastic film is located over the membrane switch circuit member, and the plural elastic element are supported by the plastic film, wherein the plural first touch detectors are disposed on the plastic film and located under the keycap of the space key, and the second touch sensor is disposed on the plastic film and located under the keycap of the neighboring key around the space key.

9. The keyboard device according to claim 1, further comprising:
a supporting plate, wherein the plural keys are supported by the supporting plate;
a main circuit board, wherein the controlling unit is disposed on the main circuit board; and
a membrane switch circuit member located under the plural keys and connected with the main circuit board, and comprising plural key intersections, wherein when one of the key intersections is triggered, the corresponding scan code is generated, wherein each of the plural keys comprises:
a keycap exposed outside the top surface of the keyboard device, wherein when the keycap is depressed, the corresponding key intersection is triggered;
a key frame contacted with the keycap, wherein the key frame stops the keycap and prevents detachment of the keycap from the key frame;
a connecting element located under the key frame and contacted with the keycap, wherein the keycap is movable upwardly or downwardly relative to the key frame through the connecting element;
a first magnetic element disposed on the keycap; and
a second magnetic element disposed on the connecting element, wherein in response to a magnetic force generated by the second magnetic element and the first magnetic element, the keycap is returned to an original position; and

10. The keyboard device according to claim 9, wherein the plural first touch detectors are disposed on the membrane switch circuit member and located under the keycap of the space key, and the second touch sensor is disposed on the membrane switch circuit member and located under the keycap of the neighboring key around the space key, or wherein the plural first touch detectors are disposed on a bottom surface of the keycap of the space key, and the second touch sensor is disposed on a bottom surface of the keycap of the neighboring key around the space key.

11. The keyboard device according to claim 1, further comprising:
a supporting plate, wherein the plural keys are supported by the supporting plate;
a main circuit board, wherein the controlling unit is disposed on the main circuit board; and
a membrane switch circuit member located under the plural keys and connected with the main circuit board, and comprising plural key intersections, wherein when one of the key intersections is triggered, the corresponding scan code is generated, wherein each of the plural keys comprises:
a keycap exposed outside the top surface of the keyboard device;
a key frame contacted with the keycap, wherein the key frame stops the keycap and prevents detachment of the keycap from the key frame; and
an elastic element located under the keycap, wherein the elastic element triggers the corresponding key intersection when the keycap is depressed, or the elastic element provides an elastic force to the keycap so as to return the keycap to an original position.

12. The keyboard device according to claim 11, wherein the plural first touch detectors are disposed on the membrane switch circuit member and located under the keycap of the space key, and the second touch sensor is disposed on the membrane switch circuit member and located under the keycap of the neighboring key around the space key, or wherein the plural first touch detectors are disposed on a bottom surface of the keycap of the space key, and the second touch sensor is disposed on a bottom surface of the keycap of the neighboring key around the space key.

13. The keyboard device according to claim 11, further comprising a plastic film, wherein the plastic film is located over the membrane switch circuit member, and the plural elastic element are supported by the plastic film, wherein the plural first touch detectors are disposed on the plastic film and located under the keycap of the space key, and the second touch sensor is disposed on the plastic film and located under the keycap of the neighboring key around the space key.
